(19) United States
(12) Patent Application Publication
(10) Pub. No.: US 2006/0289785 A1
(43) Pub. Date: Dec. 28, 2006

(54) Method for both time and frequency domain protein measurements

(76) Inventors: David McLoskey, Elaslow (GB); Glenn Baker, Paoli, PA (US); Salvatore Atzeni, Colonia, NJ (US); James Mattheis, East Brunswick, NJ (US)

Correspondence Address: Anthony C. Kuhlmann, Ph.D.;Brown Rudnick Berlack Israels LLP, One Financial Center, Box IP, Boston, MA, 02111, US

(21) Appl. No.: 11/326,977

(22) Filed: Jan. 6, 2006

Related U.S. Application Data
(60) Provisional application No. 60/641,708, filed on Jan. 6, 2005.

(51) Int. Cl. G01J 1/58

(52) U.S. Cl. 250/458.1

(57) ABSTRACT

The invention relates to methods and devices for luminescent (e.g., fluorometric) measurement. The disclosure includes frequency domain and single photon counting methods and utilizes low capacitance semiconductor light emitting devices.

### CROSS-REFERENCE TO RELATED APPLICATIONS

This application claims benefit of U.S. Provisional application 60/641,708, filed Jan. 6, 2005.

### TECHNICAL FIELD

The present invention relates to the field of both time domain single photon counting and frequency domain fluorescence measurements employing a low cost, low complexity infrared and near infrared semiconductor light emitting source, and is particularly suited for the investigation of certain biological entities.

### BACKGROUND

The characteristics of light emanating from an object or a material may be advantageously detected and analyzed in order to determine characteristics of the object or material under examination. For many years, spectrographic techniques have been used to perform analysis of materials ranging from human blood and other biological materials to slag from a crucible. For example, it has been known that wavelengths of light absorbed by a material, as well as the wavelengths of light emitted by a material during an excited state both indicate the composition of the material. Today, analytic instruments in industrial, scientific and medical applications make widespread use of such emission spectra and absorption spectra.

A specific class of analytic instruments uses fluorescence to identify materials. In such systems, an excitation source, such as a laser, is used to excite atoms or molecules, raising electrons into higher energy states. When the electrons revert back to the unexcited state, they fluoresce or emit photons of light characteristic of the excited atom or molecule. In addition, the time delay between the exciting light and the emitted light, as well as the amplitude of the emitted light, provide information about the material's composition, lifetimes, and concentration of various components.

In frequency domain fluorometers, phase delay and amplitude of fluorescence emissions are measured. An excitation source is modulated which causes the emission of a fluorescent signal. The relationship between the re-emission (phase delay) and reduction in modulation is used to calculate single or multicomponent lifetimes, energy transfer event rate constants, rotation correlation times and/or other characterstics of the modular system under investigation. By “phase” is meant the re-emission delay in degrees or time, of the modulated fluorescence emission of an unknown sample as compared to a modulated reference, which may be either the excitation source or a known sample. By “modulation”, sometimes also referred to as the modulation ratio, is meant the ratio of the amplitude of a fixed reference, either a known sample or the excitation source, to the fluorescence amplitude of the unknown sample. Frequency domain techniques are well developed in the prior art (e.g. U.S. Pat. No. 4,840,485, 5,151,869, 5,196,709 etc.) and commercial instruments are available for sale.

In another class of fluorometers, which rely on time-domain lifetime measurement, a time correlated single photon counting (TCSPC) method is employed. In this type of instrument, a measurement is made of the probability of a fluorescent photon emission after the fluorophore receives an excitation pulse. The measurement is made by counting the arrival time of individual photons within certain time periods after emission.

The light sources for both of TCSPC and frequency domain instruments suffer from similar drawbacks. They are expensive, complex, fragile, not sensitive, difficult to align and focus and their light sources can be large and require special facilities and operator training.

### BRIEF SUMMARY OF THE INVENTION

It has been observed by others that 295 nanometers is close to the absorption peak of tryptophan, and the present invention contemplates measurements of such proteins using incoherent light emitting diodes (LED) operating in this range. Moreover, in accordance with the invention the same is achieved by the measurement of proteins in silica sol-gels, without the expected effects of scattered excitation or scattered fluorescence, notwithstanding the porous nature of the sol gel medium.

While frequency domain fluorometric methods using semiconductor laser diodes in a frequency domain configuration are known, for example from U.S. Pat. No. 5,196,709 of Berndt, the same have not been usable for protein measurements.

While some work recently has been done using LEDs in the visible, the wavelength involved are of limited interest. Moreover, the failure to be able to modulate to picosecond timeframes renders such devices less than optimal. Accordingly, the standard for TCSPC measurements is the use of a flashlamp. In TCSPC measurements, the electrodes of the flashlamp require regular cleaning and the flashlamp requires regular gas replenishment. In addition to these problems, the lower repetition rate of a flashlamp, typically in the range of about 40 kilohertz increases the potential for radio frequency distortion of decays due to higher voltage switching and poorer pulse-to-pulse temporal reproducibility.

In accordance with the invention, time correlated single photon timing below 300 nm is used to gather fluorescence data. IBH software is used to analyze the data and calculate fluorescence decays. Measurements were taken using nitride semiconductor light emitting diodes and laser diodes at wavelengths spanning the visible and visible-ultraviolet boundary.

Such measurements are made possible because these devices have been found to be effective fluorescence decay measurement sources when pulsed in the sub-nanosecond timescale. Moreover, expected measurement difficulties in the measurement of native fluorescence of proteins emanating from amino acids were not experienced despite the use of a hydrated sol gel medium containing the proteins under study.

Accordingly, the inventive system provides the advantage of high sensitivity (down to the single-molecule level) and the nondestructive nature of the measurement, which one typically associates with fluorescence measurements.

In principle, when applied to a 295 nm system, the inventive system provides a method of fluorescence time-resolved measurement which, compared to prior art systems, greatly reduces the time required to observe protein interactions, while simultaneously reducing the cost and complexity of the system, and while improving both sensitivity and time resolution. In particular, in accordance with a particularly preferred embodiment of the invention, a fluorescence measurement system, particularly suited for imaging and making other fluorescence measurements for proteins, comprises a 295 nm LED as an excitation source, a frequency domain fluorometer or TCSPC instrument, a sample illuminated by the excitation source, and a detector sensitive to a range of wavelengths of interest, for example those in the range of about 295-450 nm. The informational output which is obtained using such a system contains unique information on protein dynamics. Such protein dynamics associated with the invention include the measurement of: fluorescence lifetimes and fluorescence lifetime changes associated with resonance energy transfer events, quenching of fluorescence lifetimes by quenching agents like oxygen and iodide, fluorescence lifetime changes associated with protein folding, (including de and renaturation), fluorescence lifteme changes associated with protein binding events, fluorescence lifetime changes associated with rotation-correlation times (anisotropy), fluorescence lifetime changes associated with pressure changes, fluorescence lifetime changes associated with pH changes.

The inventive use of a light emitting diode operating below 350 nm and particularly in range about 295 nanometers allows a number of key applications by using ‘intrinsic’ tryptophan fluorescence lifetimes, be they natural or engineered, as fluorescence probes for protein investigations. This is because tryptophan fluorescence intensity and the average lifetime is sensitive to the pH of the surrounding environment. Moreover, tryptophan fluorescence has two emission spectral components with separate lifetime decays. Previous instruments have found these two components difficult to resolve. The inventive system facilitates resolution of these two components by virtue of its relatively high sensitivity.

Moreover, tryptophan fluorescence can be quenched by several chemicals in solution including oxygen and iodide. Hence, in accordance with the invention the location and exposure of the intrinsic tryptophan to its outside environment, in the context of the protein, can be probed with these quenchers. This functionally allows the tryptophan fluorescence lifetime to provide key tertiary and quaternary information concerning protein folding, structure and aggregation characteristics.

In addition to this, tryptophan can accept energy down-hill from tyrosine hence fluorescence resonance energy transfer data can provide important distance information helping to interpret structural information about protein folding and structure. It is further noted that tryptophan fluorescence is sensitive to anisotropic conditions. Accordingly, solvent characteristics and or binding of protein subunits and oligomerization can be studied as changes in the rotation/polarization of the tryptophan fluorescence lifetime.

In addition, the present invention provides measurements which are independent of changes in fluorophore concentration due to the effects of photobleaching. At the same time, the ease of measurement, the availability of time discrimination and kinetic rates together with unambiguous calibration increase the attractiveness of the inventive method.

### BRIEF DESCRIPTION OF THE DRAWINGS

A method for implementing the present invention will be understood from the following description taken together with the drawings, in which:

FIG. 1 illustrates an LED spectral profile with an actual peak at about 282 nanometers in accordance with the method of the present invention;

FIG. 2 illustrates the full LED spectral profile;

FIG. 3 illustrates the full LED spectral profile relative to a hydrogen flash lamp;

FIG. 4 illustrates a human serum albumin sol gel emission scan using a 280 nm light emitting diode generated using the inventive method;

FIGS. 5a-b illustrate the fluorescence decay of human serum albumin in the hydrated sol gel using 280 nanometer light emitting diode excitation;

FIG. 6 illustrates a system for implementing the inventive method in the frequency domain; and

FIG. 7 illustrates a system for implementing the inventive method in the time domain.

### DETAILED DESCRIPTION OF THE PREFERRED EMBODIMENT

Time-correlated single photon counting (TCSPC) may be used to detect the constituent materials of an excited sample through the detection of single photons emitted by the sample in response to a periodic light excitation signal. In addition to the detection of the photon, its arrival time with respect to any reference excitation signal is also measured.

When it is desired to measure the fluorescence lifetime of a particular material, the material is excited by a pulse of light, causing it to fluoresce. Such fluorescence typically takes the form of an emitted photon which is emitted in response to and after the excitation pulse. However, the delay between the excitation pulse and the emitted photon is not fixed, but varies. These emitted photons are detected by photodetector, for example using a photomultiplier or micro-channel plate photomultipliers or single photon avalanche photodiodes. Typically, the time during which fluorescent emission may occur is divided into a plurality of signal periods. For example, if the emission is expected to occur over an emission period of n picoseconds, the emission period may be divided into fifty successive and contiguous signal periods, each having a duration of n/50 ps. The amplitude of the optical excitation pulse is selected so that for a signal period with a given duration the detection of two photons in a single signal period, for a single excitation pulse, is extremely unlikely to occur, as the same may give rise to measurement errors. The detection of multiple photons in a single measurement period is referred to as the pile up effect, and is to be avoided. Thus, for a given excitation pulse, many signal periods pass without a photon being detected. Perhaps half or less than half of the signal periods coincide with the detection of a photon. Signal periods in which more than one photon are detected are very rare.

Thus, the record of single photons detected after a single excitation pulse in a typical instrument carries little information. However, highly reliable and detailed information is generated by repeated excitation of the sample by optical pulses and generating a histogram showing the total number of photons in each particular signal period. Typically, in the signal period which follows in time most closely after the excitation pulse, very few photons are detected. In the next signal period, a substantially greater number of pulses are typically detected. The next signal period also evidences increasing numbers of detected photons, each one ideally being the product of a different excitation pulse. This trend continues during a relatively short leading edge of the waveform and then the number of photons per signal period diminishes much more gradually over time to define a typical fluorescence waveform evidencing a quick rise time and a slow decay time in the amplitude of the fluorescence emission.

In accordance with the present invention, fluorescence decay is measured by the observation of the native fluorescence of the amino acids tyrosine and tryptophan. This represents significant advantages as compared to the use of an extrinsic fluorescent probe which carries with it the possibility of disturbing the local environment. As noted above, the present invention has significant advantages as compared to the prior art techniques for exciting intrinsic protein fluorescence, including synchrotron radiation, mode locked lasers and flashlamps. The present invention allows the accumulation of data at a faster rate as well as simplified, less labor-intensive data generation.

More particularly, in accordance with the present invention, fluorescence measurements of protein intrinsic fluorescence, excited using a light emitting diode operating with an output wavelength below 350 nanometers and more particularly below 300 nanometers may be taken on human serum albumin contained within a sol gel sensor matrix.

In accordance with the invention, time correlated single photon timing is used to gather fluorescence data. IBH reconvolution software is used to analyze fluorescence decays. Measurements may be taken in accordance with the present invention using nitride semiconductor light emitting diodes (such as those marketed by Sensor Electronic Technology, Inc. of Columbia, S.C. under its UVTOP trademark) (such as the UVTOP-295). These laser diodes emit at wavelengths spanning the visible-ultraviolet boundary and down to the deep ultraviolet range and have the advantage of low input capacitance and a correspondingly fast response.

Thus, the inventive system has substantial advantages over the prior art. Besides being far less expensive than comparable laser diode devices, the inventive system has emission response times which allow superior performance. In contrast, existing frequency domain fluorometers and TCSPC instruments operate with less optimal excitation sources at this wavelength, such as modulated continuous wave sources and filters with their attendant high cost and low output of photons, pulsed lasers which have a high cost and complexity, pulsed lamps which are expensive, highly complex to operate and have a very low output of photons, and other LEDs with wavelengths or capacitances not suitable for the excitation of proteins or capable of measuring picosecond lifetimes.

The end result of the inventive system is a low-cost system with high energy output at 295 nanometers, which is ideal for the taking of measurements and imaging of proteins. The system is not complex, requiring no special facilities or training to run and maintain. Moreover, the system may be pulsed at one nanosecond in the case of a TCSPC instrument. Frequency domain instruments may be modulated at frequencies up to 300 megahertz.

As may be understood from the above, data accumulation rate in TCSPC is proportional to the excitation source repetition rate, but is limited to approximately two percent of the source repetition rate if pile-up effects are to be avoided. In accordance with the present invention, it has been found that a source repetition rate of approximately one megahertz is sufficient to accumulate the fluorescence decay of most samples in a few minutes. However, in single molecule and imaging applications higher repetition rates are preferred.

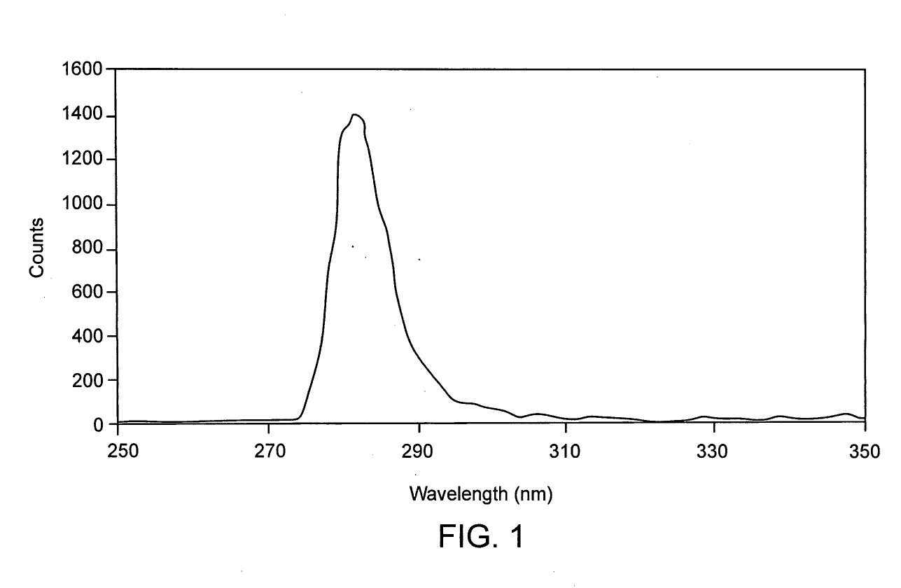

In accordance with the inventive method, AlGaN fabrication techniques are used to implement a light emitting diode in the near ultraviolet through deep ultraviolet range. A typical LED spectral profile Kumble for the excitation source used in the inventive TCSPC method and system, with an actual peak at 282 nanometers is illustrated in FIG. 1, as recorded with an IBH f/13 monochromator with a two nanometer bandwidth and incorporating a holographic grating in a Seya-Namioka geometry. The full width at half maximum (fwhm) is approximately 10 nanometers.

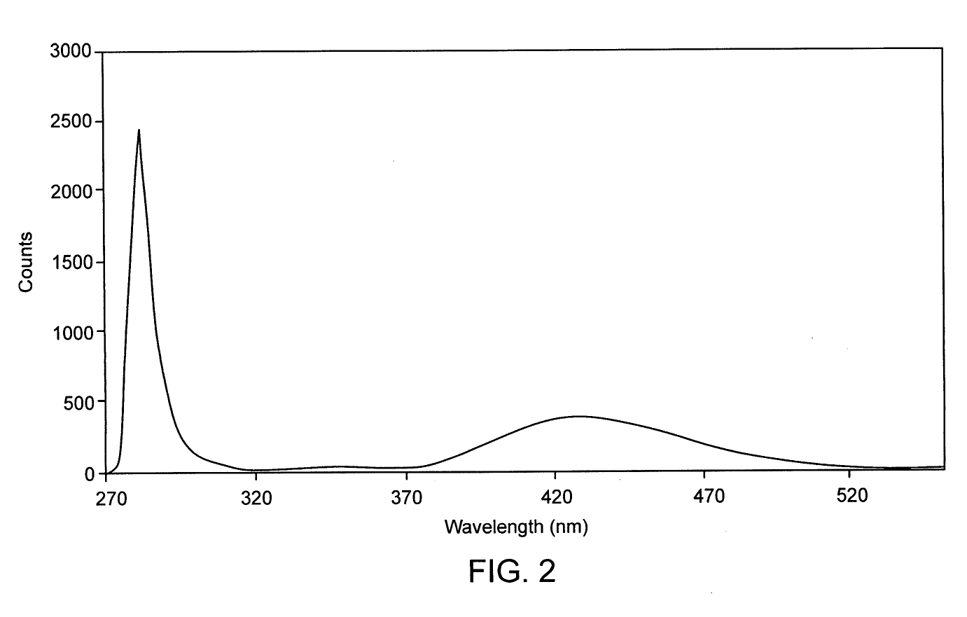

FIG. 2 shows the full LED spectral profile of the source used in the inventive TCSPC instrument, including a longer wavelength emission peak at 430 nanometers. The 430 nanometer peak cannot be used for exciting other fluorophores because of a long decay time in the range of 500 microseconds. Accordingly, it is necessary to use a cutoff filter to select optical radiation in the 280 nanometer range in order to avoid interference that would otherwise be caused by the 430 nanometer peak together with the Stokes shifted fluorescence.

In accordance with the invention, this may advantageously be achieved using a monochromator to pre-filter the LED excitation at 280 nanometers, before allowing the excitation light to illuminate the specimen under study. Additional discrimination against detecting the effects of the 430 nanometer emission peak is provided by an additional monochromator selecting fluorescence stimulated by the 282 nanometer excitation wavelength.

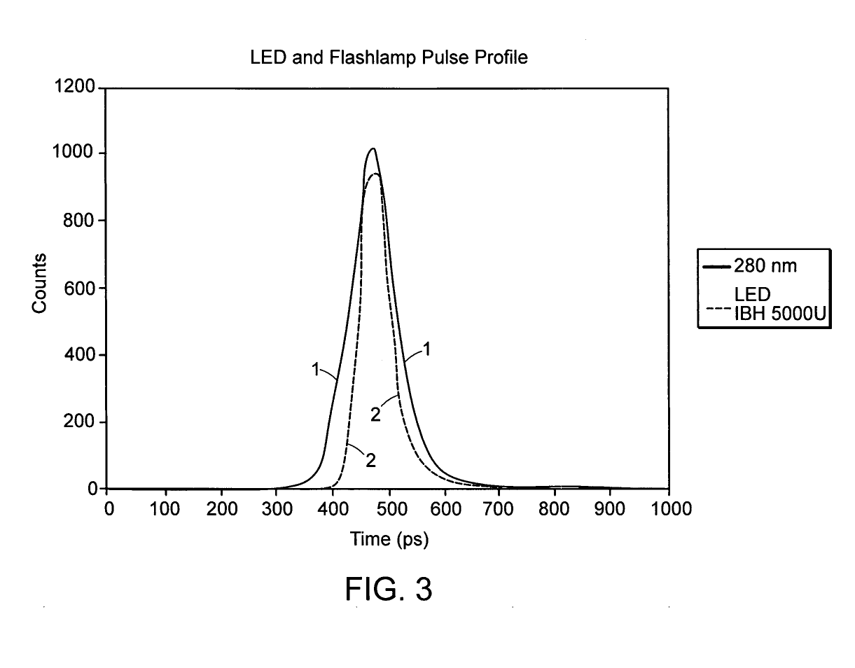

FIG. 3 shows the LED pulse profile 2 at 280 nanometers measured using photomultiplier detection and time-correlated single photon counting for a typical instrumental pulse, and recorded using an IBH TBX-04 detector under TCSPC conditions at a time calibration of 27 picoseconds per channel, as used for all the time-domain measurements herein. Here the fwhm is approximately 600 picoseconds. A typical pulse 1 from a hydrogen flashlamp is shown for comparison purposes.

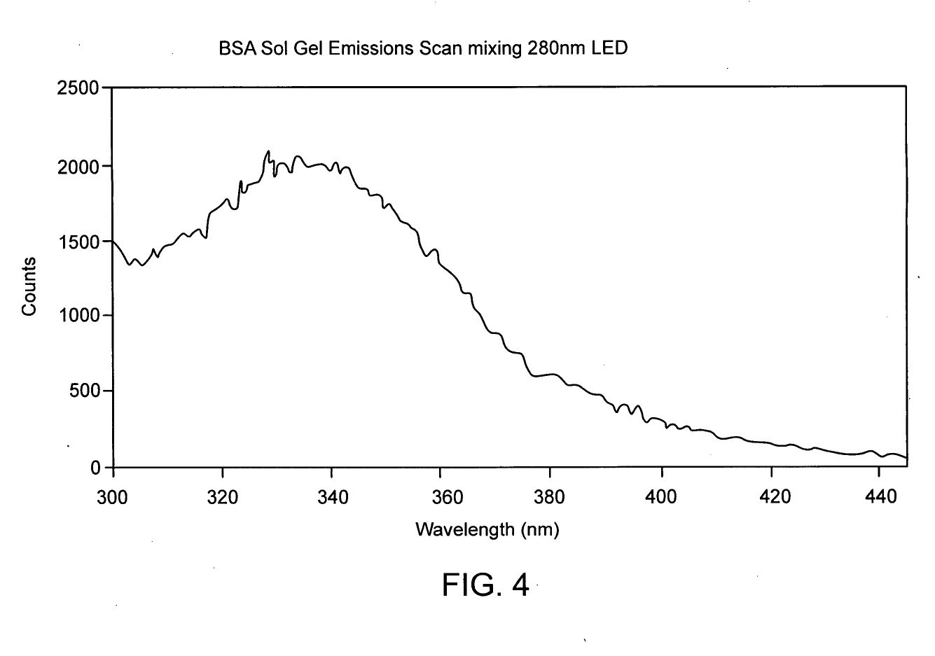

In accordance with the invention, human serum albumin in a matrix of tetramethylorthosilicate (TMOS) is prepared at pH 7.5 using standard hydrolysis and condensation reactions as reported by Brinkler and Scherer in Sol Gel Science: The Physics and Chemistry of Sol Gel Processing (Academic), 1990. An excitation source comprising a prefiltered 280 nanometer light emitting diode in an IBH Model 5000U fluorimeter produced a high quality fluorescence emission spectrum for the human serum albumin without artifacts as illustrated in FIG. 4. The excitation wavelength had a spectral bandwidth of six nanometers.

In accordance with the invention, the inventive use of an excitation wavelength below 300 nanometers to excite blood proteins in silica sol gels into fluorescence is of particular value because of the biocompatibility and nanometer pore size of the sol gel, facilitating immunoassay of analytes, such as metal ions, glucose etc. by preventing protein aggregation, transport of analytes of interest and exclusion of high molecular weight interferents, such as extraneous protein.

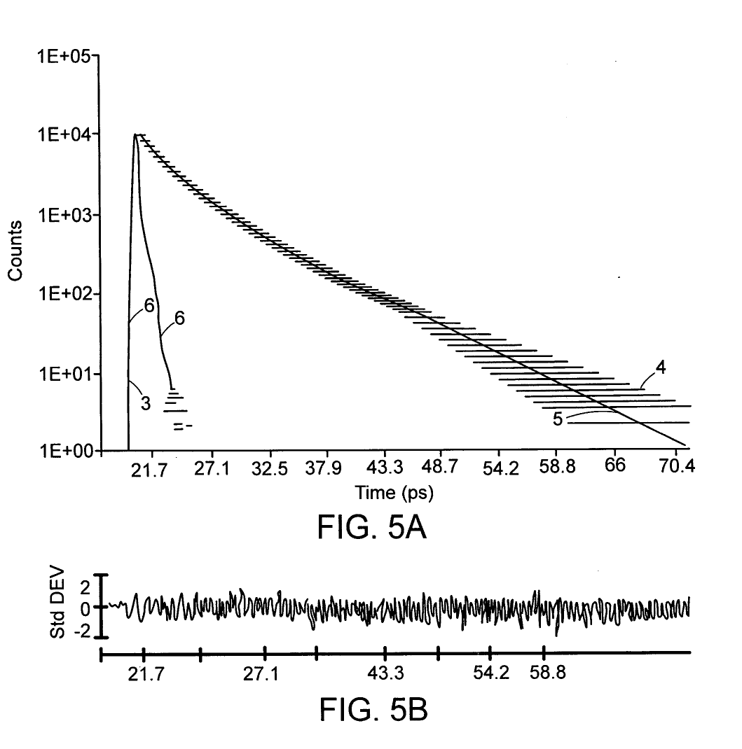

FIG. 5a illustrates the fluorescence decay 3 of human serum albumin in the hydrated sol gel using 280 nanometer light emitting diode excitation recorded with an IBH Model 5000U fluorometer equipped with excitation and emission monochromators. Raw data is indicated at reference numeral 4, and the fitted curve shown at reference numeral 5. The prompt is illustrated at reference numeral 6. FIG. 5b illustrates the standard deviation associated with the measurement illustrated in FIG. 5a. The emission monochromator is tuned to transmit 335 nanometers in order to select out the protein fluorescence. The log scale shows sharp LED pulses free from afterglow or after pulsing. For this sample, the fluorescence decay could be accumulated in approximately 2.5 minutes to 7.5 minutes depending on the actual light emitting diode used. The triple decay parameters of 0.53±0.05 nanoseconds, 2.43±0.15 nanoseconds, 6.07±0.05 nanoseconds (errors all three standard deviations) and relative intensities 8%, 38%, 54%, respectively, were found to be consistent with work in other laboratories using, for example a mode-locked laser or a hydrogen flashlamp.

The quality of the goodness of fit showed the data to be free from effects of scattered excitation or scattered fluorescence as might be expected for a porous medium. Preliminary measurements of a range of light emitting diodes at one megahertz suggested that up to 12 times higher protein fluorescence counts can be obtained as compared to a hydrogen flashlamp at 40 kilohertz.

It is noted that as well as direct tryptophan excitation at 280 nanometers, energy transfer from tyrosine to tryptophan also occurs. While 280 nanometer excitation is ideal for tyrosine excitation, fluorescence measurements on tryptophan are preferably carried out in accordance with the invention using a 295 nanometer light emitting diode which is further from to the absorption peak of tyrosine. A UVTOP295 driven by IBH NanoLED circuitry available on the market in connection with longer wavelength devices was found to work well for the particularly preferred embodiment of the invention. In accordance with the invention, a 280 nanometer excitation wavelength from a light emitting diode may be used to excite other fluorophores, including naphthalene, stilbene and so forth.

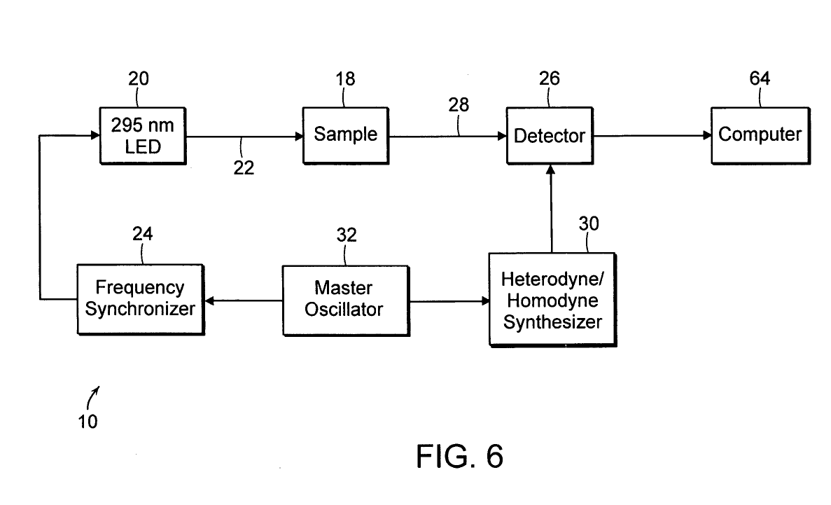

Referring to FIG. 6, a frequency domain fluorescence microscope system 10, constructed in accordance with the present invention, is illustrated. It is noted that the inventive system may be applied to fluorescence and phosphorescence systems and measurements. Sample 18 is illuminated by a source of light such as solid-state diode 20, which outputs a beam 22 of light which falls on sample 18 as illustrated in FIG. 6. Beam 22 may be prefiltered, using a monochromator in the manner described above. Diode 20 is of a type which outputs light at 290 nanometers in the event that one wishes to examine a protein sensitive to that wavelength, such as tryptophan. On the other hand, if one wishes to a examine a protein such as tyrosine, diode 20 is of a type which outputs light 22 at a wavelength of 280 nanometers. LED 20 is driven by a frequency synthesizer 24 to modulate the output of LED 20. Detector 26, which may detect radiation in the 300-400 nm range, receives fluorescence light 28, output by sample 18, which includes modulation and phase information in the manner of other known systems, and receives a heterodyne or homodyne frequency signal to output demodulated frequency and phase information. Systems of this type are shown, for example, in the United U.S. Pat. No. 4,937,457 of Mitchell. The heterodyne or homodyne signal is provided by a synthesizer 30 which, together with synthesizer 24 may be driven by a common master oscillator 32. The output of the detector 26 is analyzed by computer 64.

In accordance with the invention, beam 22 may comprise light energy which is modulated by a plurality of frequencies. Computer 64 performs a numerical analysis comprising deriving modulation and phase information in a manner conventional in the art.

Alternatively, an incoherent semiconductor light emitting device for generating light energy with temporal characteristics in the picosecond range and causing said light energy to illuminate a specimen may also be used, causing the specimen under fluorescence analysis to emit fluorescence light. Such excitation signals are selected and analyzed in accordance with the teachings in U.S. patent application Ser. No. 10/763,681 filed Jan. 23, 2004, and U.S. patent application Ser. No. 11/184,721 filed Jul. 19, 2005, the disclosures of which is incorporated herein by reference.

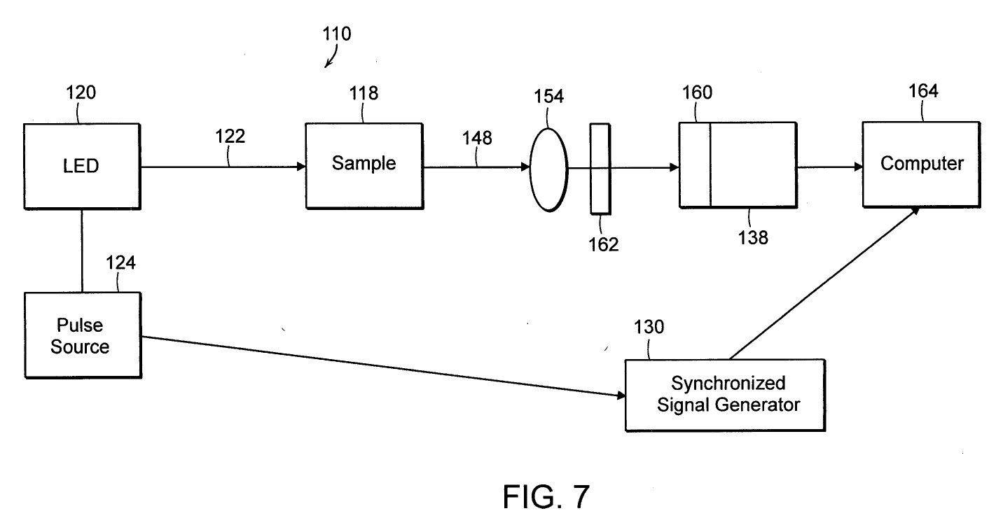

Referring to FIG. 7, a TCSPC instrument 110 is illustrated. Radiation 122 is produced by light emitting diode 120. Light emitting diode 120 is driven by pulse source 124. The output of light emitting diode 120 falls on and excites sample 118. Optionally, the output of light emitting diode 120 may be prefiltered to pass a desired excitation wavelength, such as the 280 nm peak of the source illustrated in FIG. 2, as noted above. Sample 118 contains, for example, proteins. Optionally, sample 118 may take the form of a hydrated sol gel matrix. When excited, sample 118 is caused to fluoresce in response to the pulsed light output of light emitting diode 120.

Pulse source 124 also drives a synchronized signal generator 130 which provides timing information, synchronized to the excitation controlled by pulse source 124, to a computer 164 for the purpose of accurately measuring the time delay in fluorescence emission. Synchronized signal generator 130 defines the sequential contiguous signal periods, as described above, feeding this timing information to computer 164.

Fluorescence emissions 148 from sample 118 pass through optics 154 and are imaged on sensitive face 160 of detector 138, for example a photomultiplier tube.

In principle, an image intensifier tube may be used in order to achieve a matrix of measurement points on an object and an image of a particular constituent of an object under observation. Alternatively, the inventive use of a light emitting diode may be employed in any prior art or new instrument configuration.

Returning to FIG. 7, the output of detector 138 is analyzed by computer 164. Computer 164 accumulates the total number of pulses for each signal period for each and every one of the excitation pulses produced by excitation source light emitting diode 120 during a given measurement. Typically, measurements are taken over a period of several minutes, and, accordingly, as may be understood from the above description, the photons produced by a great number of excitation pulses are represented in a single measurement. As is conventionally the case with TCSPC measurements, while numerous photons are accumulated in each measurement period, with rare exceptions, each of these photons is the product of a different excitation pulse from light emitting diode 120.

Band reject filter 162 may have the characteristic of reflecting light at the output wavelength of light emitting diode 120. Accordingly, band reject filter 162 (which may optionally be replaced by a monochromator) passes fluorescence emissions while blocking transmission of reflected light at the wavelength output by light emitting diode 120 and preventing it from overloading image intensifier tube 138. Alternatively other filters, such as high pass filters, low pass filters or bandpass filters may be used, and, depending upon the particular measurement being performed, any one or more of these filters may provide a most nearly optimum characteristic for the detection of the fluorescence wavelengths of interest while at the same time minimizing the interference of noise in the inventive system. For example, if emission is expected at a particular wavelength of interest for a particular component of interest, a bandpass filter which passes the wavelength of interest may be used in addition to or instead of band reject filter 162.

Emitted fluorescent light takes the form of fluorescent light 148, emitted by, for example, proteins in sample 118 when they fluoresce, and is focused by optics 154 onto the sensitive face 160 of detector 138.

In the case where detector 138 is an image intensifier tube, the result is an image which is accelerated and intensified by the image intensifier tube to form an intensified lifetime based fluorescence image.

While an illustrative embodiment of the invention has been disclosed, it is understood that various modifications and applications of the inventive technique will be apparent to those of ordinary skill in the art based on the instant disclosure. For example, the inventive method may be used to study not only decay kinetics as discussed in detail above, but may also be applied to emission spectroscopy, microscopy, imaging and sensing using steady-state, modulated and pulsed modes of operation.

All publications mentioned in this specification are herein incorporated by reference to the same extent as if each independent publication was specifically and individually indicated to be incorporated by reference.

Although the foregoing disclosure has been described in some detail by way of illustration and example for purposes of clarity of understanding, it will be readily apparent to those of ordinary skill in the art in light of the teachings of this present disclosure that certain changes and modifications may be made thereto without departing from the spirit or scope of the appended claims.

What is claimed is:

1. A system for gathering luminescence information from a specimen, comprising:
(a) a low-capacitance semiconductor light emitting device for generating light energy and causing said light energy to illuminate a specimen, causing said specimen to emit luminescence light;
(b) an excitation signal generator outputting a drive signal, said excitation signal generator coupled to said semiconductor light emitting device;
(c) a detector sensitive to luminescent emissions from said specimen, said detector generating electrical signals in response to detection of said luminescence light; and
(d) a computer for receiving said electrical signals generated by said detector in response to said detection of said luminescence light.

2. A system for gathering luminescence information from a specimen as in claim 1, wherein said luminescence is fluorescence.

3. A system for gathering luminescence information from a specimen as in claim 2, wherein said excitation signal generator generates a drive signal comprising a plurality of frequencies which are used to modulate said light energy output by said low-capacitance semiconductor light emitting device, and said computer derives phase and modulation information from said electrical signals.

4. A system for gathering luminescence information from a specimen as in claim 2, wherein said low capacitance semiconductor light emitting device emits light having a wavelength below 300 nanometers and said low-capacitance semiconductor light emitting device generates incoherent light energy.

5. A system for gathering luminescence information from a specimen as in claim 2, wherein said excitation signal generator generates a drive signal comprising a plurality of pulses which are used to modulate said light energy output by said low-capacitance semiconductor light emitting device, and said computer derives time-correlated single photon emission information from said electrical signals.

6. A system for gathering luminescence information from a specimen as in claim 5, wherein said low capacitance semiconductor light emitting device emits light having a wavelength between 293 and 297 nanometers and said detector is sensitive to wavelengths in the range extending from 295 to 450 nm.

7. A system for gathering luminescence information from a specimen as in claim 1, wherein said low-capacitance semiconductor light emitting device for generating light energy comprises a laser diode.

8. A system for gathering luminescence information from a specimen as in claim 1, wherein said low-capacitance semiconductor light emitting device generates light energy at a wavelength which causes tryptophan to fluoresce, but which does not cause substantial fluorescence in tyrosine.

9. A system for gathering luminescence information from a specimen as in claim 1, wherein said low-capacitance semiconductor light emitting device for generating light energy comprises an AlGaN light emitting diode.

10. A system for gathering luminescence information from a specimen as in claim 1, wherein said excitation signal generator outputs a drive signal comprising a pulse train with a pulse width in a range between 0.05 and 10 picoseconds and a repetition rate in the range between 100 kilohertz and 10 megahertz.

11. A system for gathering luminescence information from a specimen as in claim 1, wherein said excitation signal generator outputs a drive signal comprising a pulse train with a pulse width and a repetition rate to enable time resolution in the range between 0.5 and 50 picoseconds.

12. A system for gathering luminescence information from a specimen as in claim 1, further comprising a solid gel matrix for supporting said specimen to receive said light energy emitted by said low-capacitance semiconductor light emitting device.

13. A method for mapping the location of proteins in a biological entity, comprising:
(a) generating light energy at a wavelength which i) causes tryptophan to fluoresce, but which ii) does not substantially cause tyrosine to fluoresce to illuminate said biological entity, causing said entity to emit luminescent emissions;
(b) detecting said luminescent emissions from said biological entity, and generating electrical signals in response to detection of said luminescent emissions; and
(c) numerically analyzing said electrical signals to generate luminescence information.

14. A method as in claim 13, wherein said light energy is generated as pulses with a duration in the sub-nanosecond range.

15. A method as in claim 13, wherein said light energy is modulated by a plurality of frequencies and said numerical analysis comprises deriving modulation and phase information.

16. A method as in claim 13, wherein said light energy has a wavelength below 300 nanometers.

17. A method as in claim 13, wherein said generation of light energy is performed by coupling a drive signal comprising a plurality of pulses to a low capacitance semiconductor light emitting device, and said numerical analysis comprises deriving time-correlated single photon emission information from said electrical signals.

18. A method as in claim 13, wherein said light energy has a wavelength between 293 and 297.

19. A method as in claim 13, wherein said light energy is generated using a nitride semiconductor light emitting diode.

20. A system for gathering fluorescence from a specimen, comprising:
(a) an incoherent semiconductor light emitting device for generating light energy with temporal characteristics in the picosecond range and causing said light energy to illuminate a specimen, causing said specimen to emit fluorescence light;
(b) an excitation signal generator outputting a drive signal, said excitation signal generator coupled to said incoherent semiconductor light emitting device;
(c) a detector sensitive to fluorescent emissions from said specimen, said detector generating electrical signals in response to detection of said fluorescence light; and
(d) a computer for receiving said electrical signals generated by said detector in response to said detection of said fluorescence light.

21. A system for gathering luminescence information from a protein specimen, comprising:
(a) a low-capacitance semiconductor light emitting device for generating light energy and causing said light energy to illuminate said specimen, causing said specimen to emit luminescence light;
(b) an excitation signal generator outputting a drive signal, said excitation signal generator coupled to said semiconductor light emitting device;
(c) a detector sensitive to luminescent emissions from said specimen, said detector generating electrical signals in response to detection of said luminescence light; and
(d) a computer for receiving said electrical signals generated by said detector in response to said detection of said luminescence light.

22. A system for gathering luminescence information from a specimen, comprising:
(a) a low-capacitance semiconductor light emitting device for generating light energy and causing said light energy to illuminate a specimen, causing said specimen to emit luminescence light;
(b) an excitation signal generator outputting a drive signal, said excitation signal generator coupled to said semiconductor light emitting device;
(c) a detector sensitive to luminescent emissions from said specimen, said detector generating electrical signals in response to detection of said luminescence light; and
(d) a computer for receiving said electrical signals generated by said detector in response to said detection of said luminescence light.

23. A system for gathering luminescence information from a specimen as in claim 1, wherein a wavelength selection device receives the emitted luminescence light and passes light in our range about 280 nanometers.

24. A system for gathering luminescence information from a specimen as in claim 22, wherein an additional wavelength selection device selects a fluorescence wavelength range of interest.

25. A system for gathering luminescence information from a specimen as in claim 1, wherein said specimen comprises blood proteins in a silica sol gels.

26. A system for gathering luminescence information from a specimen as in claim 1, wherein said specimen comprises human serum albumin in a matrix of tetramethylorthosilicate.
